(19) United States
(12) Patent Application Publication
(10) Pub. No.: US 2010/0287597 A1
(43) Pub. Date: Nov. 11, 2010

(54) SECURITY POLICY TRIGGER FOR POLICY ENFORCEMENT

(75) Inventors: Jack Smith Richins, Bothell, WA (US); Raul Garcia, Kirkland, WA (US); Craig A. Gick, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/436,810

(22) Filed: May 7, 2009

(51) Int. Cl. G06F 21/00; G06F 17/30

(52) U.S. Cl. 726/1; 707/E17.005

(57) ABSTRACT

Described is a technology by which a user (or other entity) may be temporarily granted or denied permissions with respect to performing an upcoming a database operation. A “before” security policy trigger is executed prior to executing the database statement, so as to modify the user's security context (e.g., to add a role) prior to execution if information associated with the operation meets criteria defined in the policy trigger. The existing security system uses the (possibly modified) security context to determine whether to execute the database statement. The security context is reverted after the successful or unsuccessful execution of the database statement. The security policy trigger may also cause an error to be raised.

### BACKGROUND

In a database environment, traditional security mechanisms either allow an operation to take place or not, depending on permissions granted to a principal. This is not a very flexible security model, and often requires an administrator to perform or initiate a number of operations that businesses would prefer to other personnel perform. As a result, administrator permissions are often given to more users than is desirable, which compromises security.

One attempt to provide more flexibility is based upon Data Definition Language (DDL) triggers. DDL triggers can be used to perform administrative tasks in the database such as auditing and regulating database operations without needing an administrator each time. DDL triggers are “after” triggers, in that they are based upon taking some action with respect to a database transaction, and then either committing the transaction or rolling back the transaction.

As a result, this is not very effective with respect to security for certain types of operations. For example, backing up a database creates a new file; once backed up, the work is already done, and the file exists with its information disclosed and open to exploit. Additionally, as the operation does not go through the hardened security kernel for permission evaluation, it is more likely to be vulnerable to attack. Even if an error is raised that triggers a security-related policy action, security has already been compromised.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards temporarily granting permissions that may allow a database operation to be performed by executing a “before” security policy trigger evaluated prior to executing a database statement or the like. The before security policy trigger evaluates data associated with the database statement against criteria specified therein to determine whether a security context associated with the database statement is to be modified, e.g., by adding a role or secondary principal in association with the security context. The security context is evaluated by the existing security system to determine whether to execute the database statement. The security context is reverted after the successful or unsuccessful execution of the database statement.

In one implementation, a database engine receives an event notification from a module such as a function before an operation is to be executed. A policy trigger associated with that module evaluates information associated with the event notification to determine whether a set of one or more criteria is met by the information, and if so, to take action that modifies a security context. For example, the policy trigger may return a true evaluation result that modifies the security context, no evaluation result that leaves the security context unchanged, or a false evaluation result that raises an error and prevents any execution attempt. If not false, the security system evaluates the security context with respect to a statement for execution to determine whether to allow or deny execution of the statement. If modified, the security context is reverted to its prior state before any modification.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components in a database environment that includes security policy triggers.

FIG. 2 is a flow diagram showing example steps taken by a database security system (e.g., policy based management) to work with security policy triggers.

FIG. 3 is a flow diagram showing example steps taken by a security policy trigger to inform the database security system whether criteria are met.

FIG. 4 shows an illustrative example of a computing environment into which various aspects of the present invention may be incorporated.

### DETAILED DESCRIPTION

Various aspects of the technology described herein are generally directed towards providing a security policy trigger (or more simply “policy trigger” or “trigger”) that is evaluated prior to executing a database operation (comprising a statement or multiple statements of a database language). In general the trigger comprises logic that evaluates one or more criteria, which if the trigger evaluates to true, results in modifying a security context associated with that operation. In one implementation, the security context is modified by adding a secondary principal or role to an entity (e.g., user) token; the role can be used to grant or deny additional permissions for the duration of execution of the operation. Once the operation associated with the policy trigger is completed, whether successful or not, the modified security context is reverted, e.g., the added role is removed from the user token. If the trigger evaluates the one or more criteria to false, an error may be raised to prevent the operation.

While some of the examples described herein are directed towards Structured Query Language (SQL) statements, it is understood that the technology described herein may be implemented in any suitable database language. Further, as will be understood, languages such as C# and/or the .Net framework may benefit from using the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and programming operations in general.

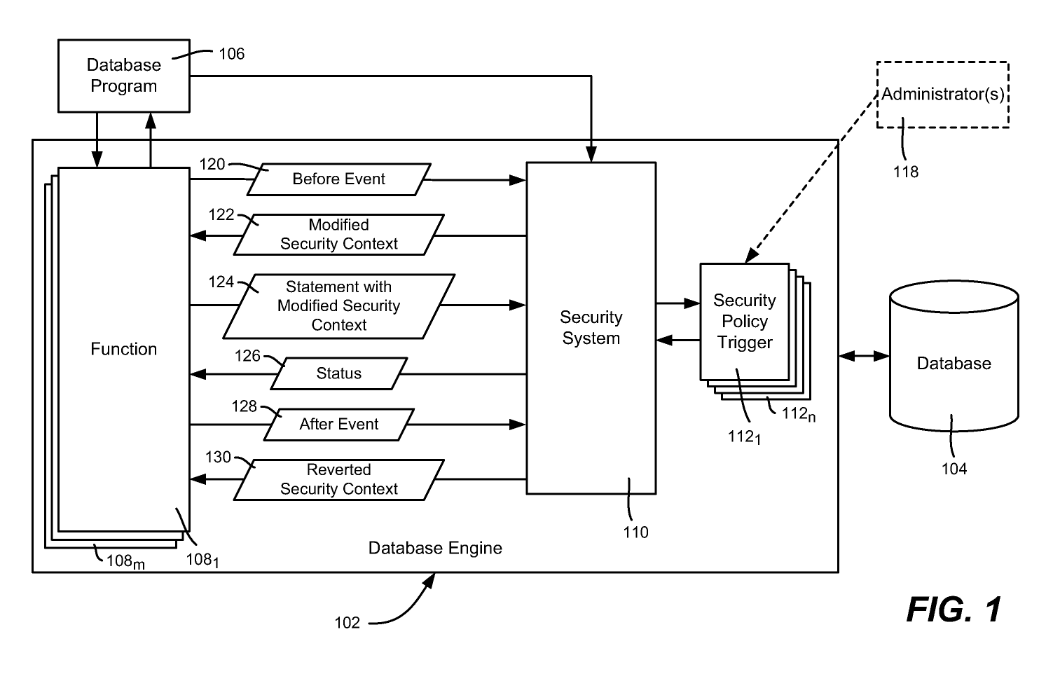

FIG. 1 shows an example database environment including a database engine 102 that provides access to a database 104. As is known, a database program 106 includes statements that when executed perform various operations with respect to the database 104. These statements may call predefined functions 108₁-108ₘ to perform various operations. Examples used herein include backup and restore functions, however any number of functions/operations/statements that may benefit from being performed with a different security context, including DDL functions, server configuration options, modify database options, select from tables, consistency checking, and so forth, and database management language (e.g., DML) operations, may use before triggers.

A security system 110 is represented in FIG. 1, and in general ensures that the only operations that can occur with respect to the database 104 are those made by principals who have the appropriate permissions. However, as mentioned above, this is not flexible, whereby enterprises that use databases desire to refine this mechanism, yet do so in a way that meets their customized requirements. For example, a business may want to allow or prevent certain operations based on context-sensitive policy, such as the time of day, and/or having a work order.

As described herein, the desired flexibility is provided via policy triggers 112₁-112ₙ, each of which contain logic that may be executed with respect to an operation (a statement or set of statements, particularly if corresponding to a function's operation) before that operation is executed. Depending on how an administrator configures a system, any operation may have zero, one, or more than one policy trigger associated with it.

In one aspect, a policy trigger may dynamically modify the user's security context (affecting permissions) for this operation, whereby authorization through the normal security code paths is performed, but with different permissions than the user normally has. In one example implementation, a policy trigger is a conditional EXECUTE AS clause, which based on some trigger-like functionality, adds a role membership to the execution context. This allows privileged execution; however it does not affect identity as reported in SQL Audit, sp_who, and so forth. Such triggers may be defined on system DDL.

Because the normal security code paths are used, the named role needs to have permission to do the desired operation; the security system 110/policy checks to determine whether the operation is allowed or not. After the operation completes, the user's security context (e.g., role membership) is reverted to its previous state.

Administrators define the policy triggers and associate one or more of them with any function/operation/statement to which the administrator wants to apply the policy trigger or triggers; this is represented in FIG. 1 via the dashed block 118 (to indicate this is done in advance) of any actual operation processing. In general, to define a policy trigger, a login or user needs to have a specific “policy admin” privilege or the like. This privilege, if present on the corresponding token, allows defining or altering these policy triggers, but in one implementation does not allow executing them to escalate the caller's privilege. This latter limitation helps secure separation of roles, so that the principal defining policy cannot control the system. In addition to disallowing a login/user with this privilege, corresponding data may be kept on the context stack so that if the defining administrator impersonates another user, that administrator is still denied elevation through policy triggers.

Turning to invoking the policy trigger or triggers for a given operation, in the example of FIG. 1, the functions 108₁-108ₘ are written to post event notifications to an internal database engine notification system; (note that FIG. 1 shows events received by the security system 110, but this aspect may be handled by a separate component). One such event, shown in FIG. 1 as a before event 120, signals the security system 110 or the like to look for any policy triggers that are applicable for this function, so that the security context has an opportunity to be modified before the upcoming statement or statements for which the function will later request execution. By way of example, if the function is a backup database function that will issue a backup statement, the notification will cause a search for any backup-related security policy triggers. Note that other before event notifications, including those possibly directed towards other security policy triggers, also may be fired by the function.

Along with the before event notification, the function provides data such as relevant flags and/or parameters, e.g., in an event object. One example is a location (e.g., of a network storage volume) to which the database will be backed up. Another example may identify or provide a ticket. In general and as exemplified below, if a policy trigger exists for this statement, the policy trigger evaluates the data to determine if criteria in the policy trigger is met, and if so, returns a “True” evaluation result to the security system. Note that for purposes of brevity hereinafter, only one policy trigger is described for each function that has one, however it is understood that more than one policy trigger may exist for a function/operation/statement, with suitable logic combining the results in some way (e.g., all need to be “True” or any one may be “True” in order to modify the security context of the user invoking the function).

If the policy trigger returns true, the security context is modified, such as by adding a role in one implementation. FIG. 1 shows this modified context 122 being returned to the function, e.g., as a token for use with the statement, however as described above, the modified context 122 may be maintained on the context stack. Also, the user identity is added to the role membership.

The function then issues the statement 124, which is associated with the modified security context. As with any statement, status indicative of success or failure is returned to the caller, as represented by block 126.

Regardless of success or failure, the function fires an after event notification 128. This is used to revert the security context of the user (or other entity) to its pre-modified state.

As mentioned above, adding a role may grant or deny additional permissions for the duration of statement execution (which may be more than one statement). Thus, the policy trigger may be used to deny an operation that the user is otherwise able to perform. As can be readily appreciated, this provides for highly flexible policy, e.g., to not allow backup or restore operations during normal business hours regardless of the caller's other permissions. Note that in some database systems, membership in certain roles trumps any grants/denies/revokes.

Further note that a policy trigger need not return “True” (or “False” as described below), whereby execution of the statement will be attempted with the normal security context of the user. Alternatively, the policy trigger may return a “False” result, which raises an error. Returning an error can be used to prevent an operation the user would normally have permission to execute.

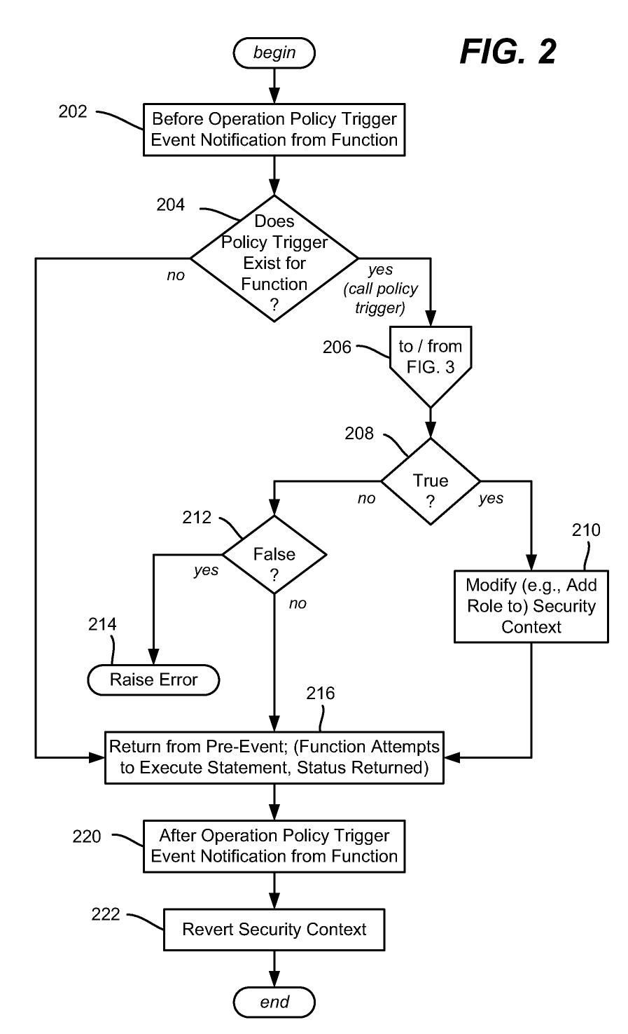

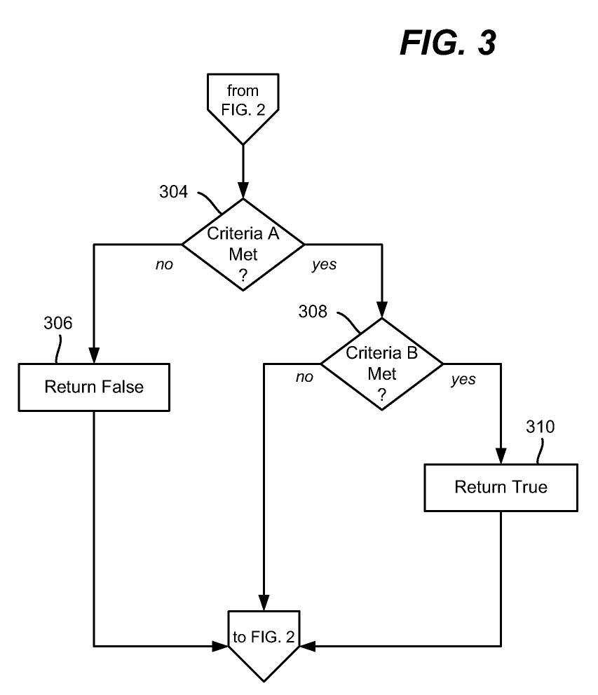

FIG. 2 comprises a flow diagram showing example steps taken by a security system or the like to handle the before event notification and after event notification with respect to a policy trigger. FIG. 3 shows example logic of one policy trigger, however as is understood, the logic may be programmed in any desired way to output a “True” (modify security context) evaluation result, a “False” (raise error) evaluation result, or neither a “True” nor “False (proceed with existing security context) evaluation result. The flow diagrams are described with respect to an example restore operation.

By way of example, consider an IT staff member assigned through a work ticket system to restore a database on a production system. The staff member has a login on a SQL server instance, but no permissions. An administrator has defined an example policy trigger for this operation as:

```
CREATE POLICY TRIGGER escRestore ON ALL SERVER
WITH ROLE sysadmin
FOR RESTORE_DATABASE
AS
BEGIN
    @dbname NVARCHAR(MAX)
    SET @dbname =
EVENTDATA( ).value(‘(/EVENT_INSTANCE/TSQLCommand/
DatabaseName)[1]’, ‘nvarchar(max)’)
    IF (select * from ticketsystemSrv.tickets.dbo.tickets
WHERE assignedto = CURRENT_USER AND servername =
@@servername AND dbname = @dbname AND action =
‘RESTORE DATABASE’)
    BEGIN
        IF (is_member (‘itadmin’))
        BEGIN
            RETURN TRUE
        END
    END
    RETURN FALSE
END
```

When the staff member logs in, he or she executes:
RESTORE DATABASE foo FROM . . .

As represented in FIG. 2, the invoked function (RESTORE) provides a before operation event notification (step 202) directed towards finding any policy triggers for this function. If one exists (step 204), the policy trigger is executed (step 206) before the restore statement itself.

More particularly, in the above example, there are two sets of criteria (IF statements) that are evaluated, as represented in FIG. 3; Criteria A (step 304) corresponds to evaluating whether a ticket matches the notification's parameters, e.g., the user, the server and database and the action; Criteria B (step 308) corresponds to checking whether the user is a certain type of administrator (“itadmin”). Depending on the actual conditions, “False” may be returned (step 306), “True” may be returned (step 310), or neither. Depending on the operation and the enterprise's desires, far more elaborate logic and/or other or more conditions may be present, e.g., only allow a restore to begin after 6 pm, do not allow if initiated from a remote location, and so on; virtually any condition that may be evaluated may be used as a criterion to help determine “True” or “False” (or neither).

Returning to FIG. 2, if “True” was returned as evaluated at step 208, the security context is modified (e.g., a role is added) via step 210. For example, adding the role may alter the staff member's security context by adding the SYSADMIN role as a secondary principal to the prior security context, because the trigger determined that the member was indeed assigned a ticket to restore a database on that system.

Conversely, if “False” was returned as evaluated at step 212, an error is raised (step 214). This may be used to prevent any further attempt to execute the operation.

In the event that a “True” or nothing (not a “False”/error raised state) was returned, step 216 executes the RESTORE statement. If “True” at step 208, the permission checks pass due to step 210's having added the SYSADMIN membership. Otherwise, the permission checks will not pass, (because in this example, the staff member had no permissions; note that in other scenarios, the permission checks may or may not pass depending on the user's non-modified security context).

Step 220 represents the function firing the after event notification. After execution completes, either through success or failure, the security context is reverted to its prior state as represented by step 222. Note that, reverting context is known technology that handles removing only what was added, if anything; however in other implementations, step 222 may include logic that only reverts the security context if it had been changed via step 210.

The function may provide more than one statement that execute with the added role. In other words, the function can perform an operation having more than one statement, which are each executed before sending the after event notification. Thus, the temporary role may be active for a single statement, or a set of statements, such as an entire module. However, note that in one implementation, reverting the security context happens automatically as part of the language runtime that is handling the execution of these functions, and thus the reverting operation may be on a per-statement basis so as to not allow the user to have an elevated context for more than a single statement.

In this manner, a user may temporarily obtain a new role for purposes of performing an operation. The role may be used to allow or deny the operation. Further, normal privileges may be revoked by a “False” evaluation result, e.g., if the user is already of member of SYSADMIN, the policy trigger may recognize this and return “False” which raises an error to prevent SYSADMINs from executing without permission.

Thus, instead of current systems that deny an operation if policy is not satisfied, which often result in granting permissions to users to perform certain but also allow them to do more than intended, the technology described herein provides a mechanism to securely elevate permissions based on policy, and only temporarily for the purpose of a certain operation. This means that users do not have elevated permissions outside of the policy, whereby users cannot disable or manipulate the triggers. In other words, by elevating permissions on demand (rather than denying if policy is violated), the need for administrator membership is reduced, which avoids users being able to bypass the triggers used to enforce the policy. If a user still finds a way around the triggers, no additional harm can be done because the user needs the trigger to successfully execute in order to obtain the permissions.

Note that various ways other than adding roles may be used to elevate permissions. For example, it is feasible to use a security trigger to change the security context by temporarily changing the user's identity. Notwithstanding, roles have the benefit of not changing the user identity, whereby audits and the like can determine what the user actually did.

As another alternative, current SQL (Microsoft® SQL Server) technology provides the capability to sign modules within the database, such as stored procedures, functions, triggers, or assemblies; (note that DDL triggers cannot be signed in one implementation). Select permissions may be granted to a login (e.g., user) associated with the certificate.

### Exemplary Operating Environment

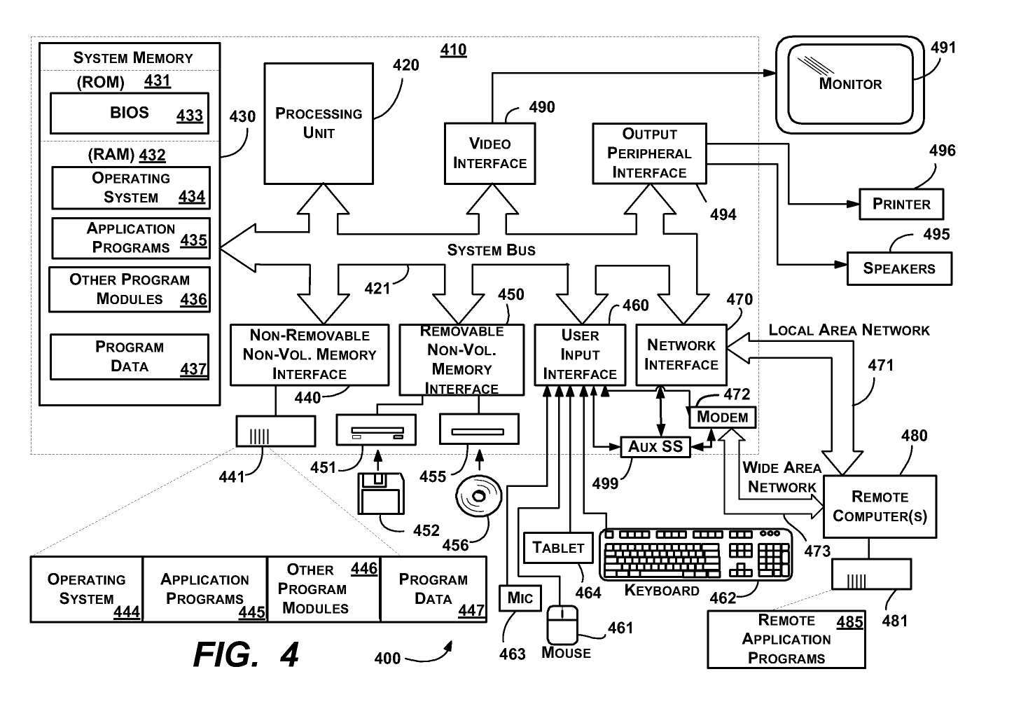

FIG. 4 illustrates an example of a suitable computing and networking environment 400 into which the examples and implementations of any of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising:
receiving information corresponding to an upcoming database operation;
evaluating the information by executing a policy trigger associated with that database operation; and
modifying a security context associated with the database operation based upon a result of evaluating the information.

2. The method of claim 1 wherein receiving the information comprises receiving a before event notification from a function.

3. The method of claim 1 further comprising, executing the database operation with the security context modified.

4. The method of claim 3 further comprising, reverting the security context after executing the database operation.

5. The method of claim 4 wherein reverting the security context comprises acting automatically after execution of a statement corresponding to the database operation.

6. The method of claim 1 wherein modifying the security context comprises adding a role.

7. The method of claim 6 wherein adding the role grants at least one permission and thereby allows performing the database operation.

8. The method of claim 6 wherein adding the role denies at least one permission and thereby prevents performing the database operation.

9. The method of claim 1 wherein evaluating the information comprises checking a storage location.

10. The method of claim 1 wherein evaluating the information comprises checking a ticket.

11. The method of claim 1 wherein evaluating the information comprises checking whether a user is an administrator.

12. In a computing environment, a system comprising:
a database engine;
a module that provides an event notification to a notification system of the database engine before an operation;
a policy trigger associated with that module that evaluates information corresponding to the event notification to determine whether a set of one or more criteria is met by the information, and if so, to take action that modifies a security context; and
a security system that evaluates the security context with respect to a statement for execution to determine whether to allow or deny execution of the statement.

13. The system of claim 12 wherein the module comprises a backup database function or a restore database function.

14. The system of claim 12 wherein the policy trigger takes the action that modifies the security context by returning a true evaluation result when the set of one or more criteria is met, and further comprising, means for adding a role associated with the security context based upon the true evaluation result.

15. The system of claim 12 wherein the policy trigger further evaluates whether another set of one or more other criteria is met, and if so, returns a false evaluation result.

16. The system of claim 12 wherein the policy trigger is defined with data definition language commands.

17. One or more computer-readable media having computer-executable instructions, which when executed perform steps, comprising:
receiving a before notification event, the before notification event associated with information with respect to an upcoming operation;
evaluating the information to determine whether the information meets one or more criteria, and if so, taking action to modify a security context associated with the upcoming operation;
processing the operation through a security system that uses the security context to determine whether to execute a statement corresponding to the operation; and
taking action to ensure that the security context is in a prior state that existed before any modification to the security context.

18. The one or more computer-readable media of claim 17 having further computer-executable instructions comprising, locating a policy trigger associated with the notification event, the policy trigger evaluating the information and taking the action by providing a true evaluation result, no evaluation result or a false evaluation result, in which the security context is modified based upon the true evaluation result.

19. The one or more computer-readable media of claim 17 wherein taking the action to modify the security context comprises adding a role associated with the security context.

20. The one or more computer-readable media of claim 17 wherein taking the action to ensure that the security context is in a prior state comprises reverting the security context.
